(19) United States
(12) Patent Application Publication
(10) Pub. No.: US 2012/0204864 A1
(43) Pub. Date: Aug. 16, 2012

(54) KLAPPGRILL

(76) Inventor: Jan Thomas Reimelt, Witten (DE)

(21) Appl. No.: 13/026,657

(22) Filed: Feb. 14, 2011

(51) Int. Cl. A47J 37/07

(52) U.S. Cl. 126/9 R

(57) ABSTRACT

The invention relates to a compact barbecue grill apparatus with a handle (G) attached to a wedge-shaped firebox (GW) serving for the preparation of food over an open heat source (WQ). The design variants A and B differ with respect to their size and as far as their footing systems are concerned, e.g. whether hinged feet (KF) or ground spikes are provided. In both variants basically smoothly and steplessly transitioning temperature zones (HY) are available with only a single grate level (R) being provided. For transportation and storage the apparatus are very compact and of space saving design since the support (S) is carried on a pivoting axis (SA) and during use is in essentially diagonal position with respect to the horizontal grate level (R) located above. Due to their integral form of construction the apparatus are quickly ready for use and can be easily cleaned.

The relevant figures are shown on the following 7 pages.

The invention relates to a collapsible barbecue grill in accordance with the preamble of claim 1.

A collapsible barbecue grill is an apparatus for the grilling of food that can be folded up so as to save space. Such collapsible or portable grilling apparatus are known. They usually have four supports pivotably arranged on the firebox in a manner similar to table legs. However, there are a number of grill designs that entail various drawbacks, primarily when using the apparatus. Known systems are often relatively small; more often than not they are instable or difficult to assemble, and/or they only offer a single heating zone due to the relevant grate adjusting options.

The most simple collapsible barbecue grills consist of U- or X-shaped hinged plate elements which are folded out, put up and then filled with coal. Grill designs of this type also have further shortcomings in that cleaning them is rather bothersome. Cleaning utensils used such as for example hand brooms or brushes often get caught up on projecting (sharp-edged) construction elements. Also, injury hazards for the user must not be underestimated.

Apart from the sometimes unsatisfying cleaning possibilities also the working height of many known systems is unfavorable for various reasons. Since many design versions are relatively small a working height that satisfies ergonomic needs is hardly achieved. Moreover, an inadequate working height frequently causes cleanliness/soiling problems regarding the preparation of food (e.g. due to the influence of wind raising dust, sand and the like).

If, on the other hand, the working height is found to be ergonomically appropriate, state-of-the-art apparatus are often of large size and as a rule need much space for transporting or storing. As far as their usage in this context is concerned they are thus unwieldy and inflexible.

To satisfy requirements of the relevant site of use and/or ground condition many systems also lack options that enable the grate level to be adjusted in horizontal direction. More often than not this gives rise to problems affecting the stability of the equipment.

State-of-the-art system designs offer more or less appropriate solutions to overcome individual or some of the problems mentioned. However, a satisfactory remedy for all of the drawbacks described above has not been put forward hitherto by a single embodiment.

It is thus the objective of the present invention to provide a collapsible barbecue grill that
effectively meets the requirements linked with ease of transport and space-saving storage,
further enhances the safe use of the apparatus,
enables the utilization range of the apparatus to be expanded.

Furthermore, the grill should be of highly compact design which with regard to materials used and sustainability
is economically expedient,
and on a long-term basis contributes to the conservation of resources.

According to the invention this objective is reached by providing a collapsible barbecue grill featuring the characteristics specified in claim 1.

One underlying idea of the present invention was to provide a support having a primarily box-shaped contour said support when in storage position will encompass the firebox. The compactness of the grill design has been achieved due to the fact that it has been equipped with a support pivotably attached to the firebox, said support, primarily, being of box-shaped design. This integral design principle not only enables the space requirements of such an apparatus to be minimized but, what is more, enables the convenience of using it and its safety to be improved in a number of aspects.

Therefore, the apparatus designed as provided by the present invention is thus a barbecue grill of compact design that aside from improved transportation and storage possibilities also offers a wider range of use.

Ease of transportation as well as the space-saving storage capability of the grill are achieved because the firebox can be adjusted in relation to the support such that it has a storage position in which it is embraced by the box-shaped outer contour of the support.

The quick setup and the straightforward use of the grill are the result of the design that provides for the firebox to be adjusted in relation to the support in such a manner that it assumes a position for use in which the grate level is mainly horizontal and the support below the firebox extends diagonally to the grate level.

Preferred further embodiments of the invention are specified in the respective sub-claims.

A preferred embodiment of the grill provides for the bottom of the firebox to be designed such that it accommodates a planar heat source and provides further that this bottom slopes down towards the pivoting axis. Due to the wedge-shaped cross-sectional configuration of the firebox smoothly transitioning heating zones are achieved with respect to the horizontally extending grate level arranged above. Since the distance between heating source and grate increases towards the pivoting axis the temperature level decreases in this direction.

Another preferred characteristic provides for the grate level edge at the support side to nearly coincide with the pivoting axis, at least when viewing the grate level from the top. This design configuration results in creating an excellent proportion as regards the grill area and the pack size.

To simplify cleaning efforts it is also considered advantageous that the firebox has been provided with an opening arranged towards the pivoting axis and that the firebox can be adjusted in relation to the support such that it can be brought into cleaning position in which the opening is located at the lowest point of the firebox. In this way ash accumulated in the firebox can be easily removed with a brush in cleaning position through this opening.

To improve the stability of the grill it is viewed expedient to provide at least one footing system which delineates a basically rectangular base or footprint, the surface area of which shall coincide in essence with the surface area of the grate. As a result of this design configuration the grill, when viewed from the side, has a Z-shaped contour through which it is well balanced and its stability improved.

When positioned on soft ground the stability of the grill can be improved by means of at least one ground spike attached to the support. For this purpose the spike is driven into the ground.

Alternatively, the stability can be optimized by providing two hinged feet slewably attached to the support, said feet being swung out into a horizontal position in which they can be locked thus forming or delineating an essentially rectangular footprint.

Preferred embodiments of the grill are characterized by the firebox being lockable on the support when in usage position and/or in storage position and/or in cleaning position.

Further characteristics of further inventive embodiments can be seen from the following description of the especially preferred collapsible barbecue grill variants A and B.

The difference between collapsible grill variants A and B primarily concerns the size of the devices as well as the design of the footing system.

Variant A of the apparatus is intended for use on hard and smooth ground such as for example asphalt or stone flooring.

Variant B of the apparatus is intended for use primarily on soft ground such as for example on lawns or sandy soils. However, it may also be used on hard ground. For this purpose an optional baseplate has been provided.

For transportation and storage purposes both variants are embraced in collapsed condition by the box-shaped support and are carried via a handle arranged on top. This results in the grill's space requirements being substantially reduced compared to the usage or cleaning positions.

To bring the grill apparatus A in usage position the hinged feet are initially released from their resting position in the support and then swung out into horizontal position in which they later give support to the apparatus. When in horizontal position the hinged feet are pushed into the support. In this manner the hinged feet are capable of absorbing the moments exerted by the support which in relation to the feet is in inclined position, and thus make sure the entire grill apparatus gains sufficient stability against overturning on the smooth ground. The grill apparatus can now be placed on the ground.

Following this, a central locking mechanism can be released that is arranged in the middle of the handle and serves to arrest the slewing movement of the firebox so that the firebox can be moved around the pivoting axis. The central lock comprises two coaxial locking mandrels which are spring-loaded in the direction of arresting points defining the relevant apparatus positions, said mandrels engaging in these arresting points to lock the apparatus in its relevant positions.

The locking mandrels are guided in a tube which also serves as handle. When the firebox is in its horizontal usage position the central lock with locking mandrel automatically engages in the respective arresting point. The grill apparatus A is now ready to operate.

Optionally, grill apparatus A is equipped with a side table which serves as a storage shelf in usage position. After the apparatus has been mounted this table is swung out of its storage position inside the support and when in horizontal position pushed home so that it is arrested in this position by means of two mandrels each arranged laterally in the support.

To bring grill apparatus B into the desired usage position on soft subsoil the entire device being in transport position is driven into the ground by means of its ground spikes. The correct entry angle is predetermined by the arrangement of the ground spikes on the support.

A pushdown aid in the form of a cutout centrally arranged in the stiffening element facilitates driving the entire grill apparatus into the subsoil by means of push force exerted by foot. The stiffening element has also been provided with a pull-out aid via which the ground spikes can be removed from the subsoil.

For use on hard ground the grill apparatus B can be provided with a baseplate which in transport position is pushed over and thus covers the front side of the support. To mount the grill on hard grounds the baseplate is removed from the support and placed in position on the ground.

The baseplate has four holding fixtures into which the front ground spikes of the support are inserted, at first perpendicularly. Moving the support into its inclined position will then cause the front ground spikes to become firmly wedged in the two front holding fixtures so that the stability of the entire apparatus is achieved in this way.

Following this, the central lock in the middle of the handle can be released and the firebox can be moved around its pivoting axis. When the firebox is in its horizontal usage position the central lock is automatically locked in place. The grill apparatus B is now ready to operate.

Depending on the design of the heat source different heat zones at grate level are provided in apparatus A and B due to the wedge-shaped configuration of the firebox with its bottom sloping down towards the pivoting axis, said heat zones may be arranged either in stages or may even have an almost stageless extension. This offers a number of very important benefits:

To suit the temperature requirements of the food to be prepared the user can decide in which heat zone the grillables shall be placed. To do so he or she need not have several grates arranged at different heights above the heat source but instead can move, position and turn grillables on a single horizontally extending level.

This arrangement will not only make it more convenient to use the grill but also make sure different kinds of food can be prepared more easily.

To thoroughly clean apparatus A and B after use the heat sources may be removed as required to suit their design (gas or coal heating system) and then subjected to cleaning. Afterwards, the firebox can be moved from usage position to cleaning position.

To achieve this, the central lock in the middle of the handle is again released and the firebox moved around its pivoting axis. As soon as the firebox has reached its upright cleaning position the central lock is automatically latched. The cutout in the firebox is now positioned perpendicular to the pivoting axis and thus located at the lowest point of the firebox.

Through this opening soiling/ash remnants etc. can be easily removed without having to move the entire apparatus for this purpose. For example, residual ash or cinder may be easily swept through this opening into a suitable container by means of a hand brush. To remove more persistent soiling (e.g. fat stains) liquid-based cleaning methods may as well be employed. Wastewater resulting from such a cleaning process can drain away freely through this low-level cutout.

After cleaning and by actuating the central locking mechanism the firebox can again be brought into transport resp. storage position in which it is again locked in place. Having returned the respective footing/baseplate systems of apparatus types A and B to their original position both variants are ready for transportation and may afterwards be stored in a space-saving manner.

With apparatus type A the hinged feet must again be latched in placed on the support. Apparatus type B must be pulled out of the relevant subsoil (grassland or baseplate). Afterwards, both grill types can be easily transported/carried via the top handle as is done with a suitcase.

The range of application is broad: for example, both apparatus types are suited for home use, e.g. in the garden, as well as for professional use (barbecues during public events, in butcher shops, restaurants or catering business).

By way of the figures described hereunder examples of the two embodiments A and B are introduced and their advantages again pointed out.

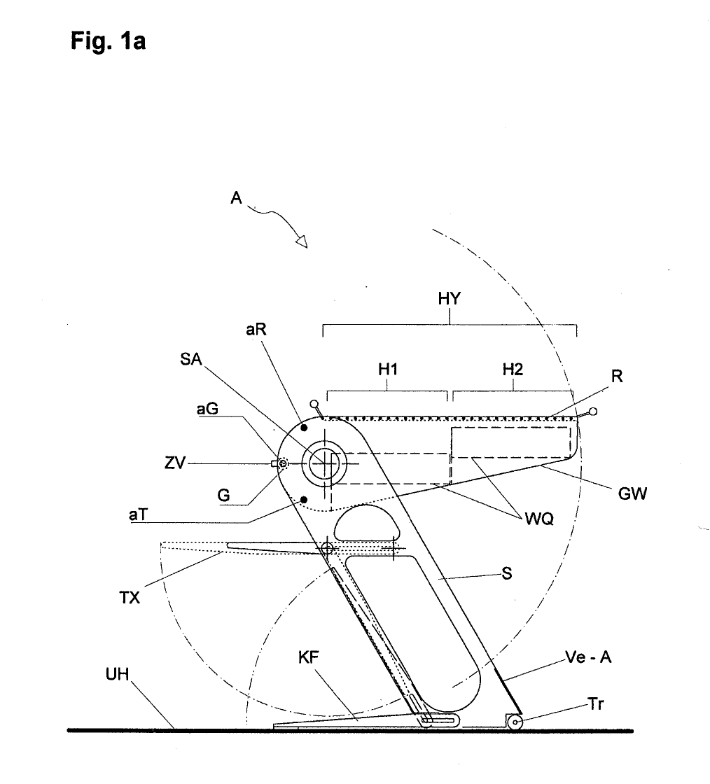

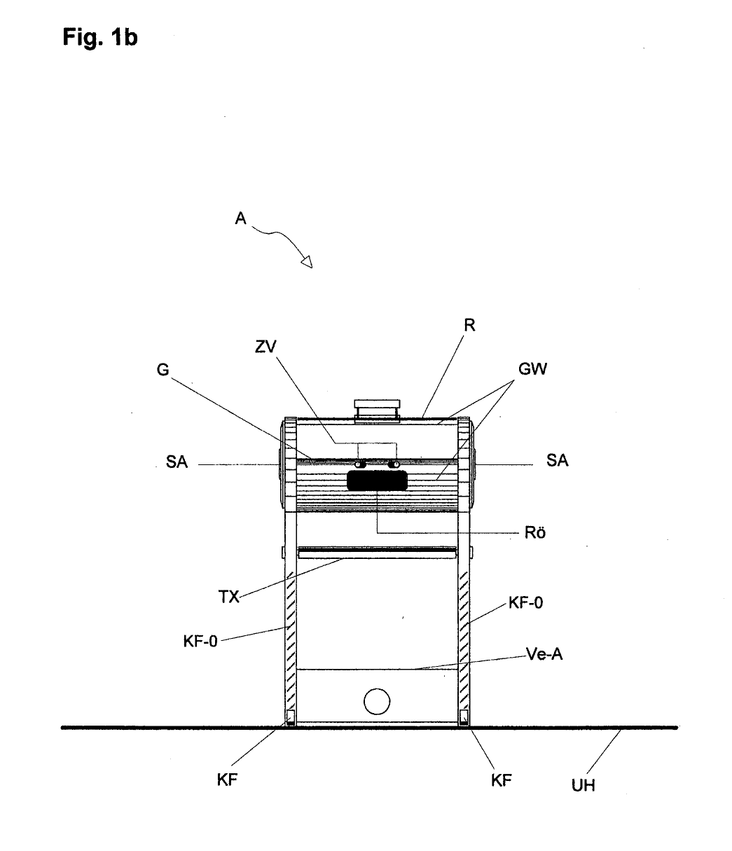

FIG. 1a: Side view of apparatus type A in usage position, with feet folded out and a hinged-out side table as well as the grill grate in usage position;

FIG. 1b: Rear view of apparatus type A in usage position, facing the firebox, the cleanout arranged in the box and the central lock located in the center of the handle;

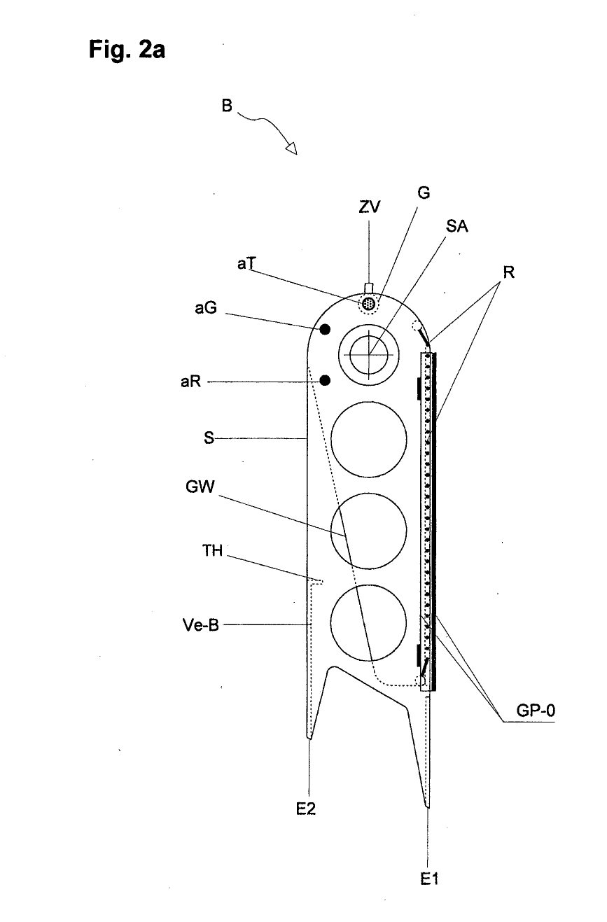

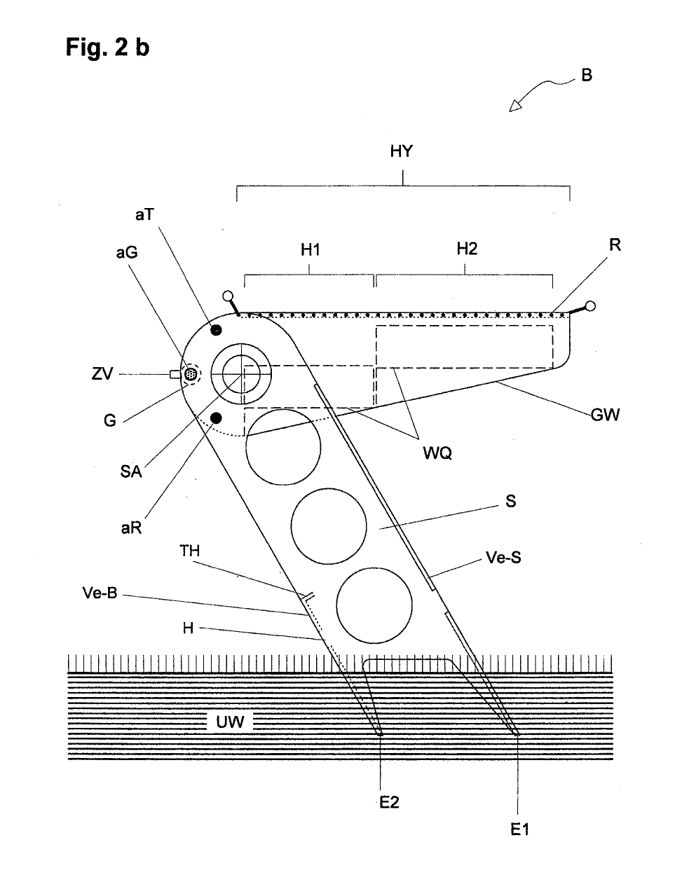

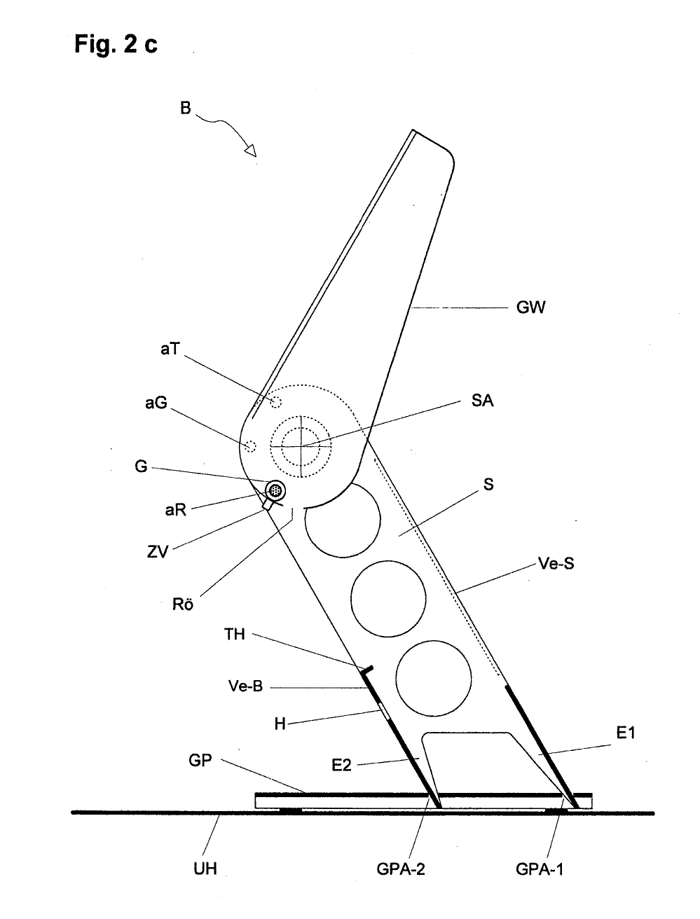

FIG. 2a: Side view of apparatus type B in vertical transportation resp. storage position, with baseplate, folded-away firebox and grill grate inserted;

FIG. 2b: Side view of apparatus type B in usage position, mounted in soft subsoil by means of the ground spikes;

FIG. 2c: Sectional system view of apparatus type B in cleaning position, without grill grate and mounted on hard ground by means of the baseplate;

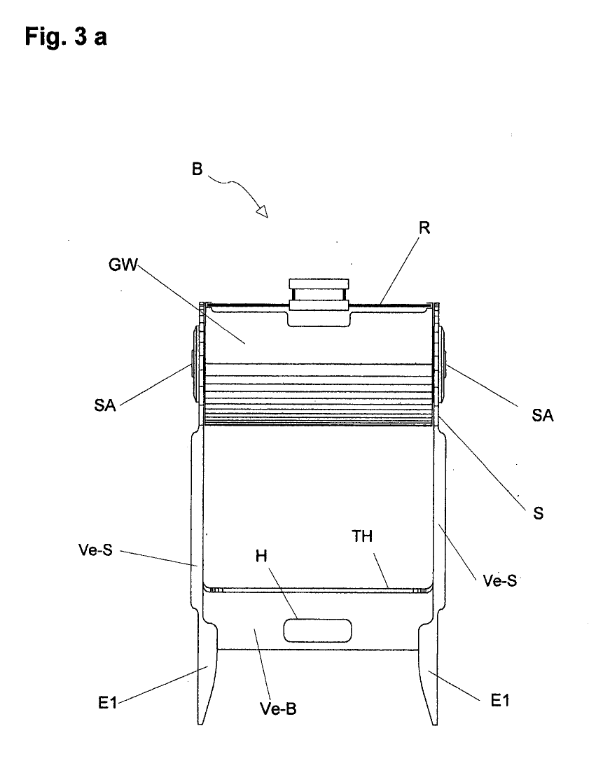

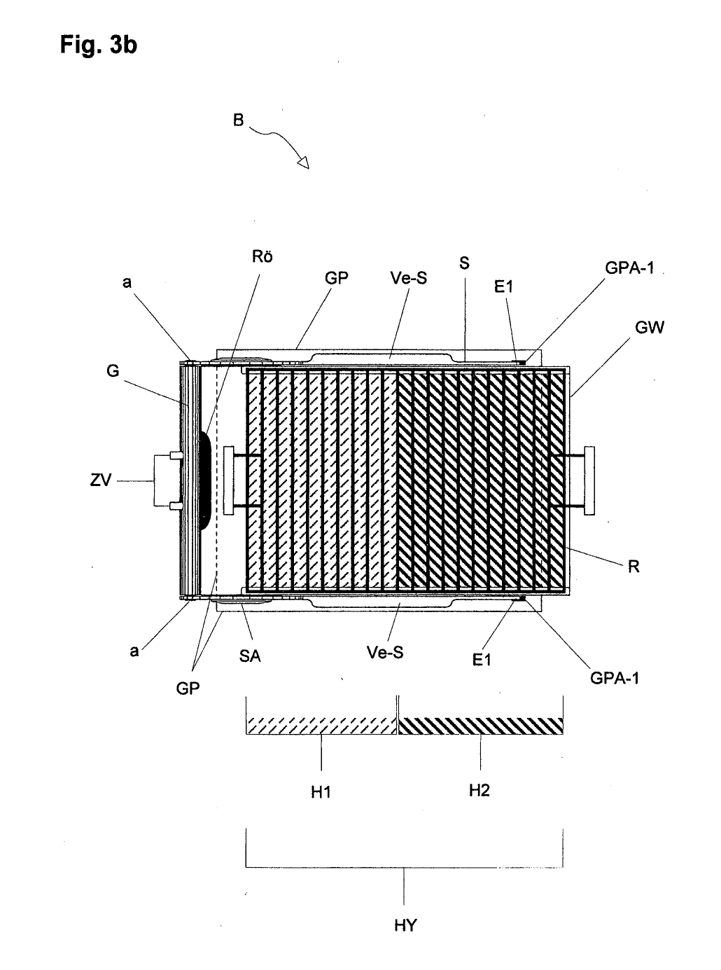

FIG. 3a: Front view of apparatus type B, facing the stiffening element including centrally arranged pull-out aid, the front ground spikes, firebox as well as the grill grate on top;

FIG. 3b: Top view of apparatus type B showing the grill grate, the firebox, the opening in the box and the central locking arrangement in the center of the handle as well as the visible lateral support elements including optional baseplate.

FIG. 1a shows a collapsible barbecue grill as apparatus variant A in usage position seen from the side, with firebox (GW) embracing an essentially rectangular grate level (R), the firebox (GW) arranged underneath the grate level and a support (S) pivotably attached to the firebox and slewable around a horizontal pivoting axis (SA), said support extending below the firebox diagonally to the grate level, as well as folded out hinged feet (KF) and an optional side table (TX) capable of being folded out via a turning-sliding joint arrangement.

The apparatus is mounted on a hard, smooth ground (UH) on which it may be moved via optional traversing rollers (Tr). The support consists of three flat walls, i.e. two parallel, preferably identical side walls flanking the firebox on both sides and a stiffening element (Ve-A) in the form of a cross member extending orthogonally between the side walls. Apart from roundings and projections all of the three walls are essentially rectangular so that the support (S) due to these walls has a more or less box-shaped outer contour. Due to the fact that all walls shown here are provided with openings and the box contour is exclusively defined by the three lateral faces forming the walls the box can be said to be of open construction. This is not in contradiction to the concept and term of a box as it is used here which is only meant to describe the abstract outer contour of the support (S). Since the outer contour of the support has been sized such that it can embrace the outer contour of the essentially box-shaped firebox and the firebox via pivoting axis (SA) has been designed so as to be adjustable in relation to support (S) the box of the support is thus capable of accommodating the firebox in storage position.

On its end opposite the firebox position support (S) is equipped with two hinged feet (KF) turnably attached on the support via a turning-sliding joint arrangement, said feet in hinged-out standing position delineate a primarily rectangular footprint, the surface area of which essentially coinciding with the surface area of the grate level (R). Therefore, within the meaning of the invention the hinged feet (KF) are thus to be seen as a footing system.

In relation to support (S) the firebox (GW) can be arrested in usage position (aG) and/or in storage position (aT) and/or in cleaning position (aR) via the central locking mechanism (ZV) located within handle (G) and via the locking mandrels (a) engaging in locking points (aG), (aT) and (aR) as applicable.

The bottom of the firebox (GW) designed to accommodate a planar heat source (WQ) slopes down in the direction of the pivoting axis (SA). As a result of the bottom slope and due to the increasing distance to the horizontally arranged grate level (R) above thus created, a temperature zone (HY) is necessarily provided that has a stageless temperature gradient which, depending on the heat source (WQ) employed, produces two essentially different heat zones (H1) and H2).

FIG. 1b shows a rear view of a collapsible grill as apparatus variant A in usage position with the firebox (GW) carried via the pivoting axis (SA), the grate level (R) situated above, the central locking mechanism (ZV), the cleanout (Rö) arranged below the central lock, and the support (S) which accommodates additional functionally important elements. These include from bottom to top the hinged feet (KF) as well as the pertinent retaining means for the hinged feet in transporting position as illustrated by the two hatched areas (KF-0), as well as the stiffening element (Ve-A) and the optional side table (TX).

The apparatus is mounted on hard ground (UH). To enable the firebox (GW) to be moved from this usage position into another position it will be necessary to unlatch from the support (S) the two locking mandrels of the central locking mechanism (ZV) by moving them towards each other. This will cause the firebox (GW) to be rotatable around its pivoting axis (SA) so that the box can then be locked in place in the desired position in arresting points (aG) or (aR).

FIG. 2a depicts as a side view a collapsible grill of variant B in storage position. The optional baseplate for hard ground (GP-0) is arranged in transporting position in this case. When in this storage position the other significant elements of the grill apparatus, such as for example the firebox (GW) and the grate (R), are surrounded by the outer contour of the support (S) so that the entire apparatus can be transported and stored in compact form in this vertical position. (This applies analogously also to apparatus variant A which for design reasons is of greater size).

For transportation the apparatus can be carried like a suitcase via a handle (G) which essentially is a designed as a round tube. Safe transportation in this position is ensured by the central locking mechanism (ZV) which is also arranged inside handle (G). Handle (G) forms part of the firebox (GW). The spring-loaded coaxially guided locking mandrels of the central lock (ZV) are latched in place in the respective arresting point (aT) which is arranged on the radius around the pivoting axis (SA) and located in the support (S). To store the apparatus brought in this perpendicular position, e.g. for wall mounting, the design of the support (S) offers several options.

FIG. 2b is a side view of a collapsible grill apparatus in the form of a smaller design variant B in usage position and without the optional baseplate for hard ground (GP) being employed, with the ground spikes (E1) and (E2) driven into a soft subsoil (UW), for example grassland or sandy soil. With the apparatus still in transporting position the support (S) can be set up orthogonally correct in soft subsoil (UW) through the orientation of the ground spikes (E1) and (E2) on support (S). For this purpose, ground spikes (E1) and (E2) are positioned on the ground (UW) in such a manner that possibly all four ends of spikes (E1) and (E2) are in contact with the subsoil.

This predetermined position enables the essentially diagonal and orthogonal orientation of the support (S) to be achieved in relation to the horizontally extending grate level (R) to be established afterwards.

In this position the grill apparatus of type B of smaller construction can be easily driven into the subsoil (UW) due to additional push force exerted by foot, similar as if driving a spade into the ground. The design and interaction of the ground spikes (E1) and (E2) produce sufficient supporting or abutting resistance in the subsoil (UW) to make sure the forces exerted during use and/or cleaning are safely absorbed and transferred into the ground. This will bring about increased stability in comparison to various traditional grill apparatus.

After the apparatus has been properly secured in the subsoil (UW) the central lock (ZV) can be released and the firebox (GW) turned around the pivoting axis (SA) and moved into usage position where the central lock is automatically engaged and correctly positioned in arresting point (aG).

The grill grate (R) can now be pulled out of its transport position and the heat sources put to use and operated.

Depending on the design of the apparatus variants the grate level (R) may be appropriately adjusted in horizontal direction.

After use and/or cleaning the grill can again be brought into transporting position. It can then be pulled out of the subsoil (UW). This is easily done by making use of the pull-out aid (H) which is provided as a cutout in the middle of the stiffening element (Ve-B).

FIG. 2c is a sectional system view as seen from the side and shows a collapsible grill apparatus in the form of a designwise smaller variant B in cleaning position, using the optional baseplate for hard ground (GP) into which the ground spikes (E1) and (E2) are inserted. In this position the cleanout opening (Rö) in the firebox (GW) is now arranged perpendicular to the pivoting axis and thus located at the lowest point of the firebox (GW).

Through this opening, which also facilitates carrying the grill, soiling/ash remnants etc. can be easily removed without having to move the entire apparatus for this purpose. By means of a hand brush, for example, residual ash or cinder may be easily swept through this opening into a container (bag, garbage can etc.) to be expediently positioned below the cleanout.

After thoroughly cleaning the system e.g. with water dirty or splash water may freely drain away through this low-level opening.

When used on hard subsoil the apparatus is inserted vertically, first with ground spike (E1), into the respective holding fixture (GPA-1) of the baseplate for hard ground (GP), following this the support (S) is lowered into its diagonal position until it securely comes to rest with ground spike (E2) in the holding fixture (GPA-2) of the baseplate.

When canting the support (S) to bring about its inclined position the apparatus is securely fixed in the baseplate (GP). From the usage and/or cleaning positions the apparatus can also be returned into its transporting position. Following this, the optional baseplate can again be put in its transport position (GP-0) on the apparatus. To achieve this, the baseplate is pushed over two lateral support stiffeners (Ve-S) arranged on the sides of support (S), as illustrated in FIG. 2a. The reference signs (Ve-S) of the lateral support stiffeners are shown in FIG. 3b.

FIG. 3a is a front view of a collapsible grill apparatus in the form of a smaller design variant B in usage position with firebox (GW), the grill grate (R), the support (S) with lateral support stiffeners (Ve-S), the two front ground spikes (E1) as well as the rear stiffening element (Ve-B) and the pushdown aid (TH) and pullout aid (H).

FIG. 3b is a top view of a collapsible grill apparatus in the form of a smaller design variant B showing the support (S) and the firebox (GW) arranged centrally in the firebox, with central lock (ZV) in the handle (G), the cleanout (Rö) located below the handle (G) and the grill grate (R) arranged at the top edge of the firebox (GW). As can be seen from the illustration in FIG. 3b the central lock (ZV) by action of the locking mandrel (a) mounted in handle (G) engages on both sides of the support (S) with the respective arresting points (aT), (aR) or (aG) provided for this purpose.

Furthermore, FIG. 3b shows the grill apparatus mounted in usage position on baseplate (GP) which is only visible in part in this representation because it is located below the apparatus. In this position the ground spikes (E1) are inserted in the relevant holding fixtures (GPA-1) arranged in the baseplate.

Moreover, FIG. 3b shows the situation of basically smoothly and steplessly transitioning heat zones (HY) on the grate level (R), with the hatched area (H1) shown dashed basically depicting the cooler temperature zone and the continuously hatched area (H2) identifying the correspondingly hotter temperature zone.

In its usage position grill grate (R) can be moved both in the direction of the pivoting axis (SA) and in opposite direction so that the heating sources (WQ) can be reached without difficulty also during operation/use, said heating sources being directly located below the temperature zones (H1) and (H2).

Up to the middle of the firebox (GW) the grill grate (R) can be moved and briefly “parked” e.g. to refill fuel material without the need for an additional storage shelf. This corresponds to half of the two respective movement directions and travel paths. This significantly reduces the risk of injuries and accidents which may otherwise arise when the hot grill grate must be removed from the apparatus as is often necessary.

Essential aspects of the embodiments shown shall again be summarized as follows:

The invention relates to a compact barbecue grill apparatus with a handle (G) attached to a wedge-shaped firebox (GW) serving for the preparation of food over an open heat source (WQ). The design variants A and B differ with respect to their size and as far as their footing systems are concerned, e.g. whether hinged feet (KF) or ground spikes (El) and (E2) are provided. In both variants basically smoothly and steplessly transitioning temperature zones (HY) are available with only a single grate level (R) being provided. For transportation and storage the apparatus are very compact and of space saving design since the support (S) is carried on a pivoting axis (SA) and during use is in essentially diagonal position with respect to the horizontal grate level (R) located above. Due to their integral form of construction the apparatus are quickly ready for use and can be easily cleaned.

### LIST OF REFERENCE SIGNS

A Apparatus type A (large collapsible grill)
B Apparatus type B (small collapsible grill)
a Locking mandrel
aT Locking mandrel in transporting position
aG Locking mandrel in grill position
aR Locking mandrel in cleaning position
E1 Ground spike (front)
E2 Ground spike (rear)
G Handle
GW Firebox
GP Baseplate for hard ground
GP-0 Baseplate for hard ground in transporting position
GPA-1 Baseplate holding fixture 1
GPA-2 Baseplate holding fixture 2
H Pull-out aid
H1 Heat zone 1
H2 Heat zone 2
HY Heat zone with stageless transition
KF Hinged foot
KF-0 Hinged foot in transport position
Rö Cleanout
R Grill grate/grate level
SA Pivoting axis
S Support
TH Pushdown aid
Tr Traversing roller
TX Side table
UH Hard ground

UW Soft ground
VE Stiffening element
VE-S Lateral support stiffener
WQ Heat source insert
N Central lock

1. Collapsible barbecue grill comprising an essentially rectangular grate level, a firebox extending below the grate level and a support pivotably attached to the firebox and slewable around a horizontal pivoting axis, characterized in that,
the grill has precisely one support pivotably attached to the firebox,
the support has an essentially box-shaped configuration,
the firebox can be oriented with respect to the support such that it occupies a storage position in which the firebox is embraced by the box-shaped outer contour of the support, and
the firebox is adjustable in relation to the support such that it assumes a position for use in which the grate level is essentially horizontal and the support below the firebox extends diagonally to the grate level.

2. Grill apparatus according to claim 1, characterized in that the bottom of the firebox is designed such that it accommodates a planar heat source and slopes down towards the pivoting axis.

3. Grill apparatus according to claim 1, characterized in that the edge of the grate level at the support side, at least when viewing the grate level from the top, nearly coincides with the pivoting axis.

4. Grill apparatus according to claim 1, characterized in that the firebox has been provided with an opening arranged towards the pivoting axis and that the firebox can be adjusted in relation to the support such that it can be brought into cleaning position in which the opening is located at the lowest point of the firebox.

5. Grill apparatus according to claim 1, characterized by a footing system which delineates a basically rectangular base or footprint, the surface area of which coincides in essence with the surface area of the grate.

6. Grill apparatus according to claim 5, characterized in that the footing system consists of two hinged feet turnably attached on the support, said feet being slewable into horizontal position in which they delineate a rectangular footprint.

7. Grill apparatus according to claim 1, characterized in that the support has at least one ground spike.

8. Grill apparatus according to claim 5, characterized in that the footing system consists of a baseplate which has at least one holding fixture compatible with the ground spike and provided so as to accommodate the ground spike.

9. Grill apparatus according to claim 1, characterized in that the firebox is lockable in relation to the support when in usage position and/or in storage position and/or in cleaning position.

10. Grill apparatus according to claim 9, characterized in that the firebox can be locked in position in relation to the support by means of a central locking mechanism which comprises two coaxial locking mandrels which are spring-loaded in the direction of mentioned arresting points defining the relevant positions, said mandrels engaging in these arresting points to lock the apparatus in its relevant position.

11. Grill apparatus according to claim 10, characterized in that the locking mandrels are guided inside a tube designed to serve as handle.
